(19) United States
(12) Patent Application Publication
(10) Pub. No.: US 2021/0218902 A1
(43) Pub. Date: Jul. 15, 2021

(54) Method and apparatus to automatically obtain images in incremental focal-distance steps using any camera/lens having a rotatable focus ring

(71) Applicant: Rheal Peter Turcotte, Oak Park, IL (US)

(72) Inventor: Rheal Peter Turcotte, Oak Park, IL (US)

(21) Appl. No.: 16/738,759

(22) Filed: Jan. 9, 2020

(51) Int. Cl. H04N 5/232; H04N 5/225; G03B 13/34; G03B 7/01

(52) U.S. Cl. CPC H04N 5/232125; H04N 5/2253; H04N 5/2254; G03B 7/01; G03B 13/34; H04N 5/232133; H04N 5/23232; H04N 5/23216

(57) ABSTRACT

This invention provides an improved method and hardware/firmware to obtain photographs of any subject ranging from insects to landscapes. It allows either manual or fully automatic collection of images in small focal distance steps by externally rotating the focus ring for any camera and any lens. The acquired photos may then be processed using commercial software to obtain a final highly detailed, entirely in-focus image. The manual method employs a very fine adjustment screw interfaced with a tab extending out from the focus ring. The automated method employs a controller and stepper motor. It drives a lead screw configured to interface with a tab extending out from the focus ring or rotates solid gears, or a motor-pully gear interfaced with a gear band secured to the focus ring. The combination of electronic and mechanical advantages leads to the possibility of focus ring adjustments smaller than 0.001 degrees.

### RELATED APPLICATIONS

US-Provisional filing—U.S. Application Ser. No. 62/922,425 filed Aug. 8, 2019, Confirmation number 3184 (mailed Aug. 23, 2019)

Related patent submission: Automated apparatus to obtain images in incremental focus-distance steps using either camera focus-ring rotation or linear translation methods (R. P. Turcotte) Submitted Jan. 9, 2020.

NA

NA

NA

NA

### BACKGROUND OF THE INVENTION

### 1. Field of Invention

This invention is in the broad field of imaging/photography and more specifically is for automated image capture in sequential focus-distance steps using still or video cameras.

### 2. Related Art

This invention provides a new method and hardware to obtain photographs of any subject ranging from very small insects to distant landscapes with the entire image in complete focus, from the very front edge to the back edge of the subject. In the past, such extended depth of field (DOF) photographs were obtained using so-called field cameras (4″×5″ film) using very small apertures and with a bellows attachment, tilting the lens vertically relative to the plane of the film to maximize DOF. This approach is still used by some for product photography because of the high resolution provided by a 4″×5″ sensor (film). Some film users have the films digitized using high resolution scanning in order to further refine the images using commercial software. Because of modern computers and digital cameras, a different approach is possible in which a series of photographs is taken in incremental focus distance steps and then combine all of these (perhaps hundreds of images) into a single composite image in which software combines in-focus regions of each image to give a final image having very high detail clarity. There are several ways to adjust the focus distance, either manually or automatically:
Rotate the focus barrel (internally or externally) (Method 1)
Move the camera and lens together on a linear rail (Method 2)
Move just the lens or just the camera (Method 3)

For the past decade or so, Methods 2 (mainly) and 3 have been used extensively by photographers and scientists interested in high resolution images. Method 2 is accomplished for small objects (Macro-photography) by use of a manual rail or a linear rail and stepper motor having a lead screw and moving platform, allowing steps in distance smaller than 0.01 mm. This method however is limited to subjects not much larger (in terms of depth) than the length of the rail, typically 10-20 cm.

Method 1 can be accomplished manually and there are a few approaches offered commercially to improve the ease of manual changes. One company (Wemacro) offers a means to automatically rotate the focus knob of a microscope to take in-depth images of microscopic objects. A few high-end DSLR and mirrorless digital cameras now offer a “focus-bracketing” feature using internal motors to adjust the focus stepwise while taking pictures at each step. These cameras work but do not offer full control of the process and require auto-focus features in both the camera and lens. Method 1 can now also be accomplished with a commercial “add-on” product—Helicon FB Tube is an extension tube with integrated electronic microcontroller designed to enable automated focus bracketing in single or continuous shooting modes. Mounted on the camera in the same way as a conventional macro extension tube, the tube automatically shifts the focus by one step with each shot thus producing any desired stack of images for later processing to obtain the final image. This device currently (2019) only works on selected Nikon and Canon cameras using selected (auto-focus) lenses.

Method 2 can be accomplished using commercial linear rail hardware and control software designed for that purpose such as by Cognisys or Wemacro. With some modifications (not currently offered) Method 3 could be executed using these rail systems.

There is another area of imaging technology that also relates to this invention, regarding taking videos with digital cameras, including inexpensive DSLR or mirrorless cameras and very expensive movie cameras using so-called cine lens often used by professionals in this field. The cine lenses often have a gear band fastened to the lens focus ring and sometimes to the zoom ring or to the aperture ring. External focus follow motors can be used on these cameras for video recording even with manual lenses. Several companies have introduced hardware to assist amateur and professional movie makers involving automated gimbal devices to minimize rapid camera movement. These gimbal frames also provide for use of the focus-follow geared motors attached to the lens barrel or camera mounting hardware and which interface with the focus ring. Though with a much different purpose, the physical arrangement is related to one embodiment of this invention and in fact uses the same kind of gear band on the focus ring that we use. The motors currently used in these devices are small, 3-phase brushless motors often used to power remote vehicles and provide about a ×6 mechanical advantage in reducing speed of rotation of the focus ring compared to the motor rotation speed. The devices are not currently intended nor controlled for the purpose focus bracketing. The purpose of the focus-follow devices is to manually or automatically smoothly change the focal distance, when for example filming a moving object. Some devices also provide the means to wirelessly rotate the focus ring from a distance as might be useful in filming wild animals.

New commercial software (even free versions) has recently become available to extract individual frames from digital videos. The ever-increasing resolution in modern digital cameras (50 mp or more) makes filming an interesting approach to capture multiple still images. Our invention allows taking advantage of hardware approaches and possibly focus follow devices related to our design to control the focus ring rotation during filming. Many digital cameras allow filming at speeds up to 10 frames per second and movie cameras deliver up to 100 frames per second. Some movie cameras now offer resolution as high as 16K, meaning each frame may contain 100 mp of data. Even for higher-end (advanced amateur) cameras, each frame contains up to 10 mp of information, suitable for high resolution imaging. This means, using this invention that 15 or more frames can be obtained in a few seconds, ideal for photography of insects, flowers, animals, etc. in nature. It could also be useful in a studio where instead of taking a few minutes to obtain 50 or more still images (for example, a portrait), it could be done in 8 seconds, or less than 1 second with a professional movie camera.

Technical considerations—before describing the focus ring control system and its different embodiments, it is useful to recognize some basic features and constraints regarding camera lens in general that lead to the design and implementation of this invention.

First, before focus stacking images using computers became possible and even now, it is common practice to use very small apertures (e.g. f32) to maximize the depth of field (DOF). When this is done, because of diffraction effects, some blurring occurs. It is commonly understood the sharpest images are obtained with the lens a few stops less than the wide-open aperture for any given lens (e.g. f5.6 or f8). Since focus stacking removes the DOF constraint, optimum lens settings can be used to deliver the sharpest image, affecting only the number of images required in the stack since the larger the aperture, the smaller is the DOF. The number of images is usually chosen to be about V2 the DOF at the desired camera-subject distance in order to overlap in-focus regions. This often leads to stacks of 20-200, or more images. One photographer (L. Biss) produces extraordinary photos of large, colorful insects using microscope lens with very shallow DOF and in total takes as many as 10,000 images for the final extraordinary product.

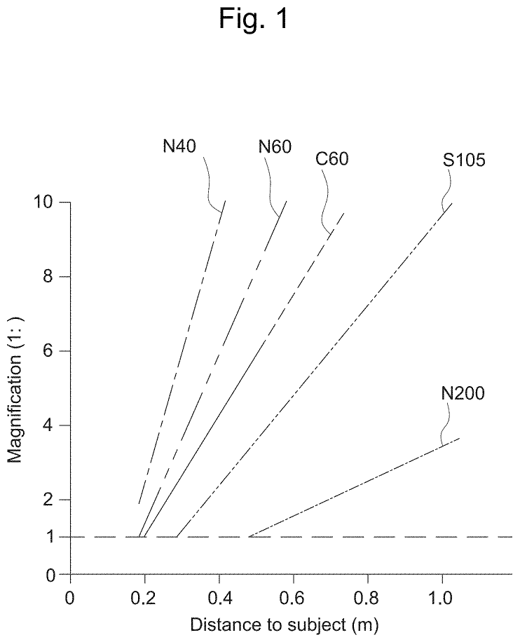

Second, the common linear rail approach of incrementally moving the camera and lens together to focus the front through to the back of the subject, involves a considerable change in magnification as shown in FIG. 1 for various lenses, being highest for short focal length lens (40 mm) compared to a telephoto lens (200 mm). Even moving the focal point just 0.1 m from the front to back of the subject results in a magnification change from m=1:1 to m=1:2+. This change in magnification (50%+) is easily understood from simple lens-maker equations derived from the physics involved. It can similarly be shown that because the changes in lens position using the focus ring method are so small (2% or so) as to not be very important. We have shown this to be true, experimentally. This suggests the focus ring approach should be better than the linear rail method because the corrections needed for focus stacking are so much smaller. It turns out that the commercial software available (we use Helicon) does a good job regardless of the magnification corrections, however we do see improved resolution for the focus ring method compared to the linear rail method, using the same camera, lens, lighting, etc. This topic is further discussed in a second patent submitted. (Turcotte)

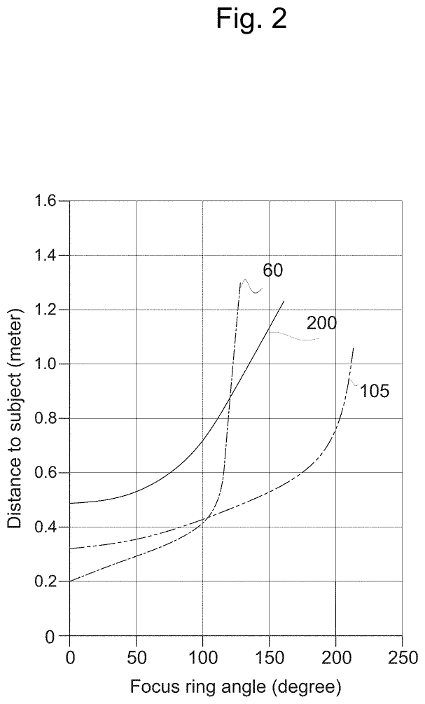

Third, although the linear rail method is precisely linear in distance/step, the focus ring on any lens is quite non-linear regarding focus distance, as displayed in FIG. 2, for three different focal length lens. While every lens is somewhat different, they have a common form, with a relatively linear distance/rotation angle dependence at short distances (<1 m) reaching a knee at (1-2 m) and then rapidly rising at longer distances. For example, the focus ring for the 105 mm lens rotates over 150 degrees in going from 0.3 to 0.4 m (100 mm total), and another 100 degrees or so to go from 1 m to 20 m. This non-linearity is easily seen by the markings on most prime lens.

This behavior is important for the leadscrew/tab embodiment of the invention, because for practical mechanical reasons, it does have an angular range of about 120 degrees during any one stack collection. Thus, in order to cover the entire depth range from the nearest point out to infinity (about 250 degrees rotation), it would be necessary to do two or more series of photo collections. It would be better to do so anyway, because many fewer shots are needed at long distances since the DOF increases dramatically in that range.

### REFERENCES CITED

USA Patents

| | | | |
|---|---|---|---|
| U.S. Pat. No. 7,616,877 | B2 | November 2009 | Zarnowski . . . |
| U.S. Pat. No. 8,009,371 | B2 | August 2011 | Sue . . . |
| U.S. Pat. No. 8,287,195 | B2 | October 2012 | DeZeeuw . . . |
| U.S. Pat. No. 8,305,453 | B2 | November 2012 | Terauchi |
| U.S. Pat. No. 8,493,461 | B2 | July 2013 | Baker . . . |
| U.S. Pat. No. 8,532,477 | B2 | September 2013 | Kazami |
| U.S. Pat. No. 8,570,396 | B2 | October 2013 | Rapaport |
| U.S. Pat. No. 9,016,960 | B2 | April 2015 | Gutierrez |
| U.S. Pat. No. 9,094,611 | B2 | July 2015 | Kennedy |
| U.S. Pat. No. 10,154,203 | B2 | December 2018 | Ferren |
| U.S. Pat. No. 10,264,171 | B2 | April 2016 | Ikeda |
| U.S. Pat. No. 10,365,500 | B2 | July 2019 | Hu . . . |
| U.S. Pat. No. 10,367,989 | B2 | July 2019 | Tanaka |
| U.S. Pat. No. 10,368,015 | B2 | July 2019 | Choe . . . |
| US2019/0174054 | A1 | June 2019 | Srivastava . . . |
| US2019/0191145 | A1 | July 2019 | Chang . . . |
| US2019/0230289 | A1 | July 2019 | Flanigan |
| US 2019/0238737 | A1 | August 2019 | Matsuno . . . |
| US 2019/0238757 | A1 | August 2019 | Sugaya |
| US2019/0238781 | A1 | August 2019 | Kobayashi . . . |

### OTHER PUBLICATIONS

Johnson, Jr. Charles S. Science for the Curious Photographer, Natick, Mass.: A. K. Peters, Ltd. 2010.
Biss, Levon. Macrosculpture, Portraits of Insects. New York, N.Y.: Abrams, The Art of Books. 2017.
Taylor, David. Mastering Macro Photography. East Sussex, UK: Ammonite Press. 2017.
Scarpino, Matthew. Motors for Makers: A Guide to Steppers, Servos, and Other Electrical Machines. Indianapolis, Ind., Que Publishing. 2017.
Cremona, Julian. Beyond Extreme Close-Up Photography. Wiltshire, UK. The Crowood Press, Ltd. 2018.
Linear rail-Cognisys. https://www.cognisys-inc.com
Linear rail-WeMacro. https://wemacro.com
Software/hardware-Helios. https://heliconsoft.com
Software-Zerene Stacker. https://zerenesystems.com
Focus follow-Neewer. https://Neewer.com
General Photography/DOF www.bobatkins.com

### BRIEF SUMMARY OF THE INVENTION

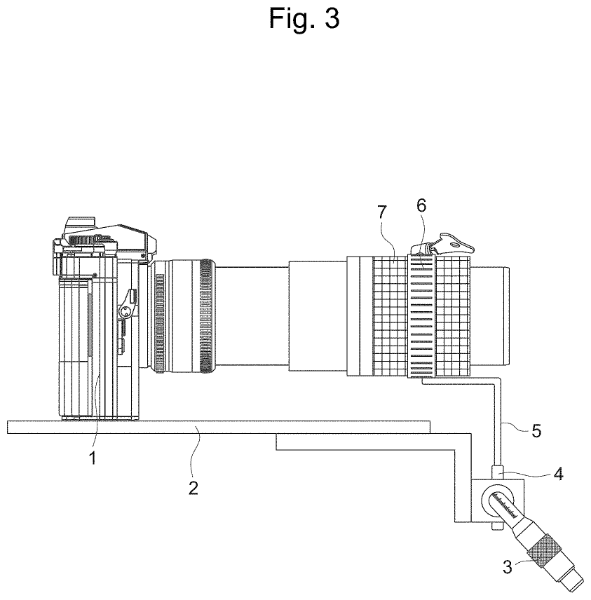

This invention allows either manual or fully automatic collection of images by externally moving the focus ring for any camera and any lens. The manual method (see FIG. 3) employs a very fine adjustment screw interfaced with a tab extending out from the focus ring in such a way that that changes in rotation angle (steps) can be smaller than 0.001 degrees, though usually much larger steps are used. (0.01-1.0 degrees).

The automated method employs either a stepper motor/lead screw configured to interface with a tab extending out from the focus ring or use of solid gears or a pully gear to interface with a gear band secured to the focus ring. Because the low torque required to turn the focus ring, the stepper motor can be controlled to deliver very fine micro-steps even though the power is reduced by doing so. For example, the typical stepper motor delivers 200 steps per 360-degree rotation of the axle. Using micro-stepping, we can adjust this to be 3200 or more steps to achieve 360-degree rotation. The combination of electronic and mechanical advantages allows focus ring adjustments in extremely small increments, even smaller than needed.

### BRIEF DESCRIPTION OF THE DRAWINGS

The following drawings (3-13) define the primary embodiments of this invention which include two basic hardware configurations—one in which all hardware is attached directly to the Camera/lens and another in which most of the hardware is attached to a rigid platform that is mounted on a tripod.
1. The Magnification factor (1:x) is plotted for various focal length lenses and manufacturers as a function of distance to the subject showing larger changes the smaller the focal distance of the lens
2. The focus ring angle for 60 mm, 105 mm and 200 mm lens is plotted as a function of distance to the subject showing strong non-linearity such that the angular change from the shortest focal distance to 1 meter is about the same or larger than for the change in going from 1 meter to infinity, for all lenses.
3. This figure depicts a manual method to rotate the focus ring by means of a micrometer adjustment screw interfacing with a rigid arm extend down from the focus ring.
4. This figure shows use of a stepper motor mounted on the base of a lens by which means a pulley-gear-band interfaces with a gear band on the focus ring, thereby allowing motor-controlled rotation of the focus ring. Solid gear(s) on the motor axis can be used instead of the pulley-gear band.
5. This figure shows a plate-mounted pulley gear band method to rotate the focus ring in such a way that no asymmetric torque is applied to the lens/camera
6. This figure shows a plate-mounted, solid, double-gear method to rotate the focus ring.
7. This figure shows how a commercial motor-driven, linear rail can be adapted to execute focus ring rotation by extending the leadscrew and using a pulley gear-band to connect the pulley gear at the end of the leadscrew to the focus ring above.
8. This figure shows a Z-channel mounted motor/lead screw/moving plate (magnet) method to rotate the focus ring by means of a rigid arm extending down from the focus ring.
9. This figure shows how the moving plate (magnet) on a leadscrew is magnetically coupled to the focus ring using a steel roller bearing on the tip of the rigid arm connected to the focus ring thereby allowing its rotation through an angle up to about 120 degrees.
10. This figure shows a Z-channel mounted motor/lead screw/moving platform/magnet confined to a rail in order to rotate the focus ring by means of a rigid arm extending down from the focus ring.
11. This figure shows the Electronic Controller used to control the stepper motor functions as well as trigger the camera shutter.
12. This figure shows a Block Diagram for the electronic system.
13. This figure shows the Controller Flowchart in terms of its shooting sequence logic.

### DETAILED DESCRIPTION OF THE INVENTION

Introduction—This invention allows either manual or fully automatic collection of images by externally moving the focus ring for any camera and any lens. The manual method (see FIG. 3) employs a very fine adjustment screw interfaced with a tab extending out from the focus ring in such a way that that changes in rotation angle (steps) can be smaller than 0.001 degrees, though usually much larger steps are used. (0.01-1.0 degrees).

The automated method employs either a stepper motor/lead screw configured to interface with a tab extending out from the focus ring or use of solid gears or a pully gear to interface with a gear band secured to the focus ring. Because of the low torque required to turn the focus ring, the stepper motor can be controlled to deliver very fine micro-steps even though the power is reduced by doing so. For example, the typical stepper motor delivers 200 steps per 360-degree rotation of the axle. Using micro-stepping, we can adjust this to be 3200 or more steps to achieve 360-degree rotation. The combination of electronic and mechanical advantages allows focus ring adjustments in extremely small increments, much smaller than needed.

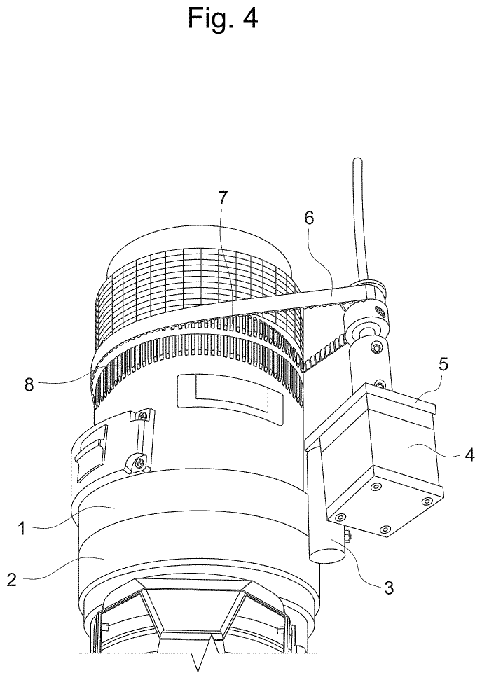

The invention includes the ability to mount all the hardware needed directly on the lens barrel and focus ring (see FIG. 4) but because a tripod is needed anyway, it is preferred to mount the hardware on the tripod to allow easy removal of the camera for hand-held photography if desired.

Unlike methods 2 and 3 described earlier, this Method (1) is suitable for close-up macro work, for portraits, for product photography and for landscape photography. It can take thousands of photographs, though normally 100 or so, extending from a few centimeters out to infinity and any smaller distance range of interest.

The invention is highly portable (<1 Kg) with nominal dimensions 10 cm×10 cm×30 cm for the Z-channel support structure and uses a small 9-12V DC power pack to power a Nema-17 stepper motor. Because our controller turns off power to the motor between series (unlike current commercial rail systems) and because so little power is needed to rotate the focus ring (compared to moving a 2-3 kg camera and lens), many thousands of shots can be taken with a single battery pack before recharging.

Method of use—Because photography in general and especially the focus-stacking method is dependent on the DOF/distance conditions in its execution, it is useful here to give a few examples of how the controller is used in order better understand the method regarding the appropriate step size and number of steps which are somewhat different for every situation. With some experience, the method is simple to execute. Here are a few examples—
1. Macro photography of a large insect or beetle might require images taken to a depth of 0.05 m into the subject, starting at 0.4 m. Using a 105 mm macro lens and aperture f5.6, as shown in FIG. 2, this would require the focus ring to be rotated from 120 degrees to about 160 degrees, or about 40 degrees total. At 0.4 m, the DOF is 4 mm, meaning we would want to use 2 mm steps in terms of distance. In terms of the focus ring rotation angle, we know the distance of 0.05 m will require 50 mm/2 mm=25 steps requiring 40/25=1.6 degrees for each step. Just to be sure, one might instead use more steps having smaller changes—for example, use 30 steps, each with 1.3-degree rotation.
2. Product photography with the same lens might require a depth of 0.25 m from the front to the back. Such imaging might be done from 1-meter distance. This would require the focus ring to be rotated from about 220 degrees to 230 degrees. At 1 m, the DOF is 0.030 m and at 1.25 m it is 0.048 m. Using the smaller number, we want the steps to be 0.25 m/0.015 m=17 in number (10 degrees/17=0.6 degrees per step). To be conservative we might use 25 steps, each rotating the ring by 10/25=0.4 degrees.
3. As a landscape example, you might want to photograph a scene from 1 m out to distant mountains. For such work you would usually want to use a wide-angle lens such as 25 mm or perhaps a 60 mm lens for a narrower field of view. In the 60 mm case, you would also consider using a smaller aperture, like f22 to give a more favorable DOF. The desired focus range in terms of focus ring angle is from 120 degrees at 1 m, out to 140 degrees at infinity. So, as in previous examples, you could achieve the 20-degree ring rotation in 200 steps at 0.1 degree per step. But because the DOF is so large, and the hyperfocal distance is reached at less than 5 meters, you really need only cover about 10 degrees rotation to cover from 1 to 5 meters, using 100 steps at 0.1 degree per step or even just 50 steps at 0.2 degrees per step would work.

These three examples suggest it will often be the case that taking 100 shots or less for any subject will be adequate, depending on the lens and aperture used. Note that the usual linear rail method (moving the camera and lens together) would require a 25 cm rail for example 2 and example 3 could be accomplished only with a much longer rail, or with a very wide-angle lens. (In fact, for 20 mm and lower focal distance lens, everything will be in focus from 1 m to infinity by focusing at the hyperfocal distance (2 m for 20 mm, 1.4 m for 16 mm) and only one picture is needed. If you intended to create a gigantic wall poster, you might use 4 or 5 shots and focus stacking to enhance the foreground.)

We can also use the controller in a somewhat different manner than described by the pervious examples and which may be important as software evolves. Because of the nonlinear behavior of camera lens regarding DOF as a function of distance, and the nonlinear behavior of focus ring rotation to select the focus distance, the use of fixed steps in terms of rotation angle may not be best. It is possible by reprograming the drive chip in the controller to automatically change the step size as each step is taken. In this way, it would be possible to make the step sizes be larger as the focus distance increases but maintain that the step size is still about ½ the DOF at that distance. This would minimize the number of shots required and may allow improvements in the rendering of the stack as well. Since we have not yet refined this alternative, all the discussion and examples in this submission refer to what we might call the “standard means” to control the process, meaning the steps are all the same in terms of angle of rotation. The “advanced means” suggested here would use different step sizes depending on the focal distance in moving from the front to the back of the subject.

Regarding the length of time involved, we typically use 1-2 seconds per step. That means taking 100 steps requires 100 to 200 seconds. We previously identified the use of video to acquire the needed images. It is worth remembering that by using the method of this invention to control focus ring rotation while filming at 7 frames per second, 100 images can be collected in 15 seconds and with a true cine camera, 1 second would be enough. Processing the 100 images in Helicon software may take 30 minutes or more.

Regarding measuring the rotation-angle change desired, a typical lens has a diameter of 7.5 cm, with a circumference of 23.5 cm. So, rotating the focus ring by 1 cm produces an angle change of 360/24=15 degrees. To be precise, an inexpensive digital level meter can easily measure changes to 0.01 degrees. In any case the user focuses at the very front of the subject, notes the ring position and then focuses at the back, again noting the ring position. This is easily done using colored tape to mark the positions. Movement by 2 cm would mean 30 degrees rotation and you would set the step size to cover that range in 100 steps or so. The method is especially simple for digital cameras because it is so inexpensive and easy to acquire the images—if too large a rotation angle is used, simply discard those not needed by visual inspection, before processing.

Finally, this invention utilizes various gear bands such as those used in printers and computer numerical control (CNC) equipment where stepper motors provide precise positioning for printer heads or various tools. The fiber reinforced band material is available in both 6 mm and 10 mm (preferred) wide versions with gear teeth about 0.8 mm deep. There are various solid gears that mate with the gear band. The cine cameras and various focus follow devices use a thicker neoprene/rubber gear band 7.5 mm wide and with gear teeth about 1.5 mm deep and there are also solid gears that mate to these. It is also possible to purchase gear bands custom made to fit most lens and targeted to the video community. In a commercial embodiment of this invention, the gearing would be customized for that purpose and deeper gear teeth like 2 mm would be even better.

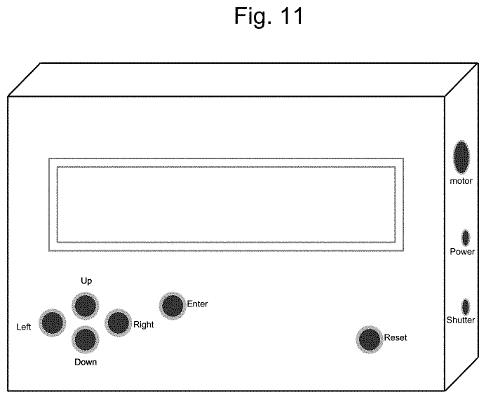

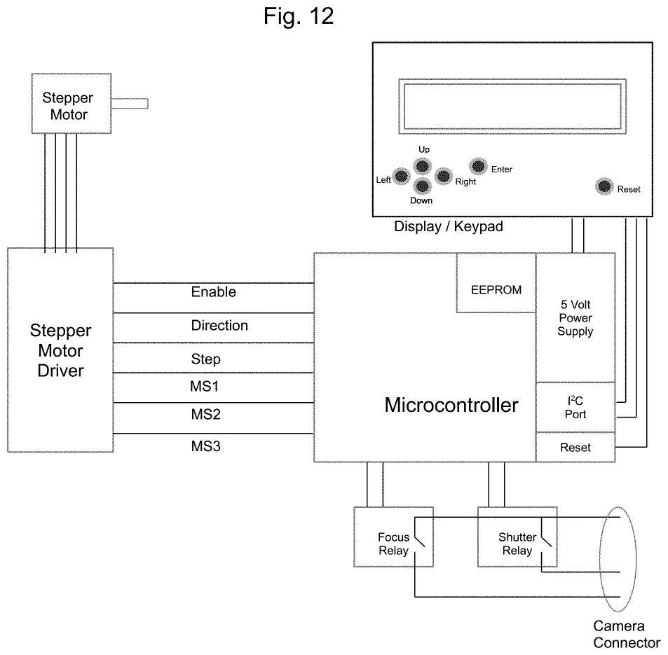

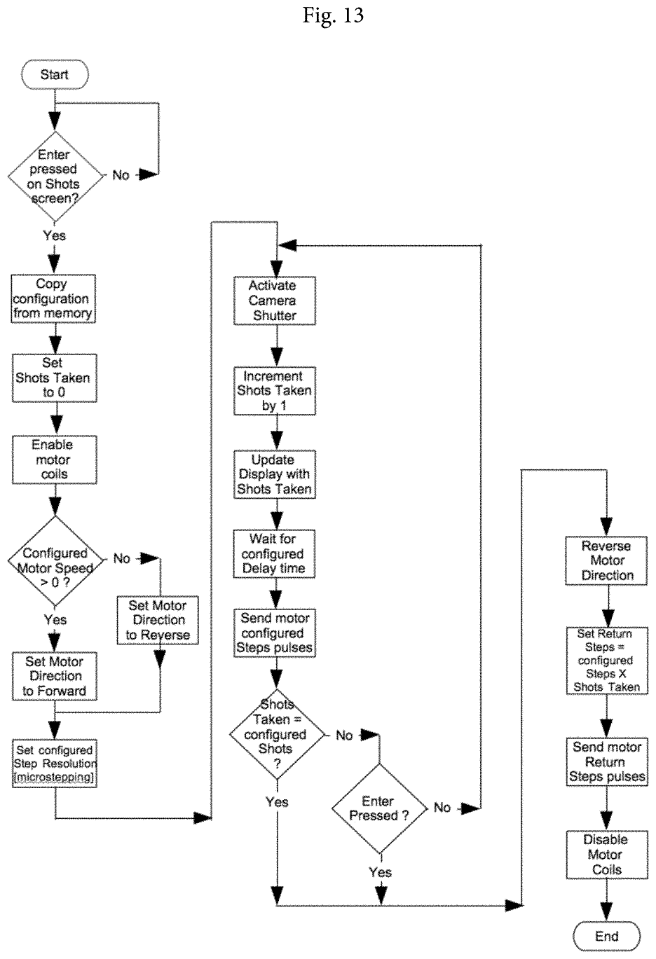

Controller functions and use—A controller is used to adjust several important factors in using this method to vary step size, number of steps, etc., depending on the subject distance and corresponding DOF. The controller is shown in FIG. 11, consisting of an aluminum box of approximate dimensions 10 cm×9 cm×4 cm. It of course could be made smaller or larger if desired, though the screen needs to be readable. We considered incorporating the battery power supply into the control box but favor an external plug-in module. FIG. 12 provides more information about the electronic components and FIG. 13 displays a flowchart regarding details of the shooting sequence logic. It would also be possible to utilize a smart phone as the controller, with appropriate software and transceiver at the motor.

The following table describes the various screens/control options and the range in variables currently set as the standard ranges, but which can be readily adjusted by reprogramming the control chip.

| Screen | Description | Range |
|---|---|---|
| Shots | Number of motor positions and | 1 to 500 |
| | camera shots (photographs) to | |
| | be taken in sequence. Pressing | |
| | the Enter key while the Shots | |
| | screen is displayed starts a | |
| | camera shot sequence. | |
| Steps per Shot | Motor increments between shots. | 1 to 4000 |
| Motor Speed | Magnitude of value is | −50 to 50 |
| | proportional to the frequency of | |
| | motor step commands (negative | |
| | values denote reverse direction). | |
| Delay | Number of seconds to wait after | 1 to 120 |
| | taking a photograph before | |
| | moving to the next position. | |
| Step Resolution | Stepper motor increment for each | Full step (1.8) |
| | step. (Micro-step setting, one of | Half step (0.9) |
| | 5 selections shown at right). A full | Quarter step (0.45) |
| | step = 1.8 degrees rotation, the | Eighth step (0.225) |
| | normal step size for these motors. | Sixteenth step |
| | The angular step sizes are indicated | (0.11) |
| | in brackets as degrees. | |

A camera shooting sequence is initiated by the user by pressing the Enter keypad switch while the initial Shots screen is displayed.

The embedded software
Retrieves all above configuration settings from microcontroller memory,
Enables the motor coils and sets the motor direction based on the sign of the Motor Speed parameter and then
Produces a series of motor movements and camera shutter control relay activations as determined by the configuration parameters, essentially taking the configured Shots photographs interspersed with an equal number of motor movements.

The progress through the sequence is displayed on the liquid crystal display (LCD), for example, “Performing shot 8 of 100”. At the end of a shooting sequence, the motor direction is then automatically set opposite to its initial setting and the motor is returned to its initial position by sending a series of motor increments equal to the photographs taken (steps) multiplied by the Steps per Shot. At that point, the motor coils are disabled. The user can then start a new shooting sequence with the same configuration or change the configured parameters. An active shooting sequence can also be aborted by pressing the Enter button.

### Primary Embodiments of the Invention

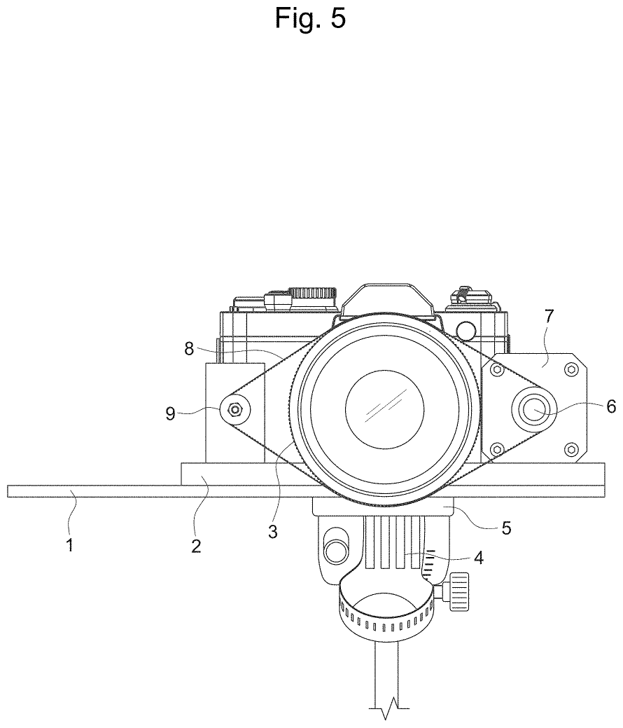

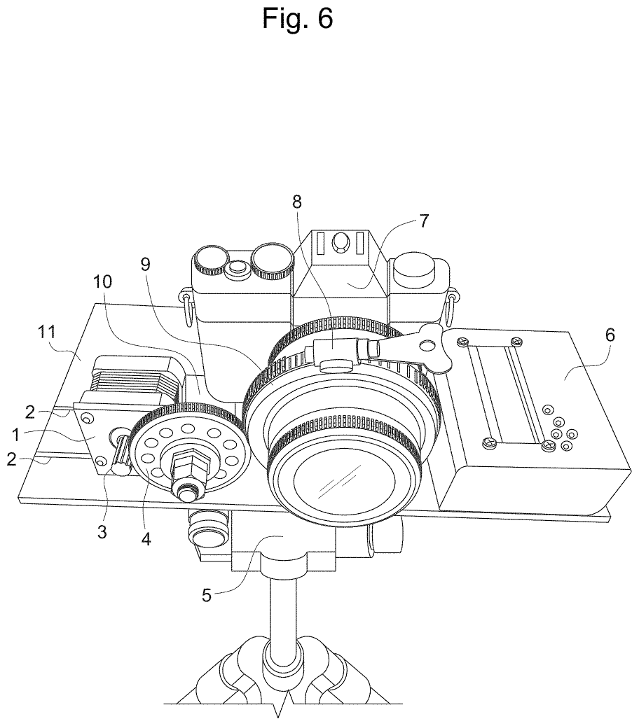

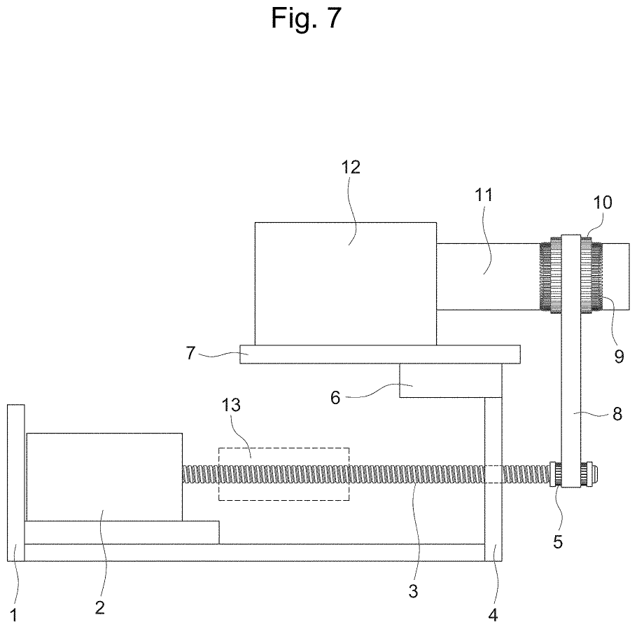

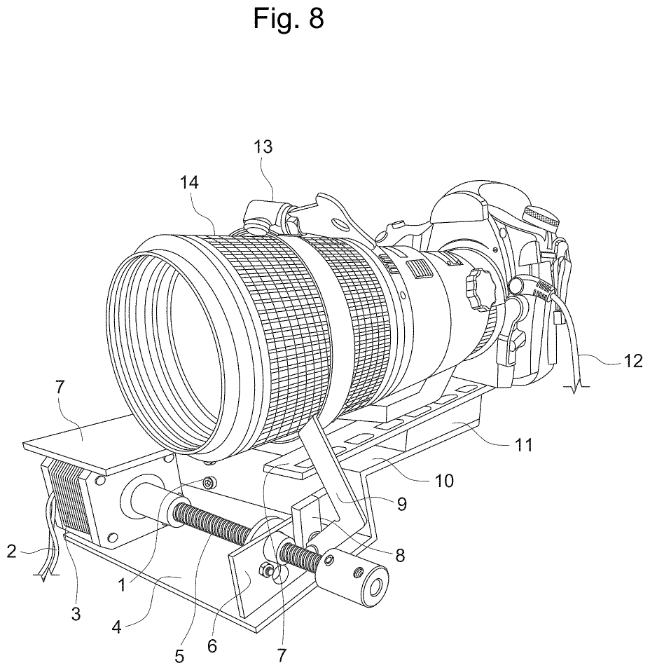

There is one manual configuration shown (FIG. 3), though the micrometer adjustment screw could be attached either to the structure, or to the rigid part of the lens barrel. For the automated systems on the barrel, there are two gear driven configurations possible (FIG. 4). For hardware mounted to a plate, there are two related embodiments involving gears (FIGS. 5, 6) and for Z channel mounting, there are two means to utilize lead screw/ring-tab ring rotation (FIGS. 8-10). It is also possible to adapt commercial, motorized linear rail/lead-screw hardware to execute focus ring rotation as in FIG. 7. All the configurations use a common controller (FIGS. 11-13). Though not depicted, it is also possible to use a commercial linear rail/lead-screw system mounted below and at 90 degrees to the camera/lens as the means to control rotation of the focus ring using the rigid tab extension from the focus ring down to the moving platform on the rail.

FIG. 1. Magnification factor (1:x) for various focal length lenses and manufacturers.

This figure shows the magnification changes for different lenses as a function of distance to the subject. Note that at the point of closest focus, 4 lens achieve m=1:1, being so-called macro-lens, while one lens reaches only 1:2. At the 1:1 condition, the subject fills the sensor area, being about 40 mm×25 mm for full-frame cameras. At 1:2, the subject only occupies about ½ the sensor area. The magnification changes are larger for short focal length lens (40 mm) compared to telephoto lens (such as 200 mm). Lens of the same focal length are different in their magnification dependence vs. distance for different manufacturers. The lens shown include Nikon 40 mm, Nikon 60 mm, Canon 60 mm, Sigma 105 mm, and Nikon 200 mm. Note for example the magnification changes for the Canon 60 mm lens are a factor of 10 through about 0.4 meters change in distance. So, using the traditional linear translation method, even moving just a distance from front to back of a subject=0.04 m (40 mm) changes magnification by 100%.

FIG. 2. Focus ring angle versus subject distance for several lens

This figure shows the nonlinear relationship between the subject distance and focus ring rotation angle. For all three lens-200 mm, 105 mm and 60 mm, the focus ring rotates about 100 degrees going from the point of closest focus (1:1) to a point about 0.2 m further away. Although not fully shown here, the distance from about 0.8 m out to infinity requires only about another 50-150-degree rotation depending on the lens. This characteristic, along with large increases in DOF as distance increases have a strong influence on how the method is executed, being somewhat different in dealing with close-up, mid-range, and long-distance photography subjects.

FIG. 3. Manual micrometer screw method

This figure displays the most simple, manual method of precisely rotating the focus ring to incrementally change focal distance and then take the desired series of photographs by using a manual electronic shutter release to minimize inadvertent camera movement. In this manner, the camera (3.1) is mounted on a plate (3.2) which in turn is attached to a tripod (not shown). An L-shaped extension arm (also attached to the releases plate) and attached micrometer mounting plate support the micrometer screw (3.3). As an alternative, the micrometer screw could also be attached to the solid part of the lens barrel with an appropriate clamp and extension hardware. The tip of the micrometer screw is iron and is strongly attracted to the bar magnet (3.4). The bar magnet is attached to the lower portion of a rigid L-shaped arm (3.5) which in turn is attached to the focus ring (3.7) by means of a clamp (3.6). The micrometer screw typically has a range of only 2.5 cm, but 5 cm screws, or longer are available. Rotating the focus ring by 1 cm produces an angle change of 360/24=15 degrees. Because of the geometric position of the screw, movement at that point by 1 cm is only ⅓ cm at the focus ring and produces 5 degrees rotation. This means a 5 cm screw movement moves the ring 25 degrees. As discussed through examples given earlier, the rotation angle needed may be more than 25 degrees which would require either taking two or 3 series of photographs, or using a 10 cm screw or longer, one could cause rotation of 50 degrees or more.

Regarding sensitivity, a typical micrometer can easily be read/adjusted to within 0.0001 cm, meaning the angular resolution will be to 0.0005 degrees in rotation, well smaller than needed.

FIG. 4. Barrel mounted pulley gear band

This figure shows one method of automated rotation control of the focus ring in which all the hardware is attached to the lens. In this embodiment, a metal band (4.1) is attached to the solid base of the lens barrel (4.1). A hinge-pin (4.3) is also attached to the metal band and it in turn is connected to a stepper motor (4.4) by means of an attached mounting plate (4.5). The motor could be for example a Nema 14 or even Nema 11 motor because very little power is needed to rotate the focus ring. The motor in any case turns a pulley wheel which in turn rotates a moving gear band (4.6) interfaced to an identical pitch gear band (4.7) fastened directly to the focus ring (4.8). Although not shown, a double solid gear arrangement (as shown in a plate mounted embodiment (FIG. 6) can replace the pulley-gear band. It is also possible to remove the asymmetric force involved in the same manner shown in the next FIG. 5), by attaching a free-wheeling pulley gear to the band (4.1) and opposite to the drive gear, by means which the gear band (4.6) would then contact the focus ring only at symmetric points above and below the lens.

Regarding sensitivity, the mechanical advantage is about ×6 for both the solid gear and pulley-gear band embodiments, so the motor axle must turn 360 degrees 6 times to cause the focus ring to move 360 degrees. At the normal step size for this motor of 1.8 degrees per step, (200 steps per 360 degrees), the focus ring will rotate 1.8/6=0.3 degrees per step. Using micro steps at 1/16 the normal size, the resolution is 0.02 degree per step.

FIG. 5. Plate mounted pulley gear band

While mounting hardware on the lens barrel is clearly possible, we consider it better to mount the hardware directly on the tripod in such a way that the camera can be easily removed and used in conventional hand-held photography, without the encumbrance of external hardware. This figure shows a front view of a plate mounted embodiment in which the plate (5.1) is directly mounted via a quick connect clamp (5.5) to a tripod (5.4). The camera/lens is also attached to this plate via a quick connect clamp, in this example in such a way that the large lens extends out from the front edge of the plate. The motor (5.7) drives a pulley wheel (5.6) which in turn drives the pulley gear band (5.8). The moving gear band interfaces exactly (same pitch) with a gear band solidly attached to the focus ring. The moving pulley band, by way of a freewheeling cylinder (5.9) interfaces with both the top and the bottom of the lens with slight compression, to maintain the gear band-to-band interface, without putting any asymmetric force on the lens or camera, as occurs with arrangements from just one side. In order to properly (and conveniently) tension the pulley band, both the motor (5.7) and free-wheeling cylinder (5.8) are mounted on a T-channel, allowing their adjustment toward or away from the lens.

The sensitivity of this embodiment is about the same as for mounting the pulley system on the barrel as in FIG. 4, being about 0.02 degrees per step.

FIG. 6. Plate mounted, solid double-gear

In this figure, we show how solid gears can be used to rotate the focus ring. In this case, all the hardware and camera/lens (6.7) are attached to a single plate (6.11) which can be of any dimension but might be about 10 cm by 30 cm and 3 mm thick. The plate (6.11) is attached to a tripod via a quick release clamp (6.5). In this example, there is room for the controller (6.6), as well as for the battery power pack which can be placed just under the controller. The camera is mounted to the plate via a quick release clamp and can move forward and back to align the focus ring gear band (6.9) with the position of the mating solid gear (6.4). The mating gear (6.4) is driven by the motor gear (6.3). The mating gear and motor are attached to a face plate (6.1) which in turn is mounted on a sliding plate (6.10). The sliding plate is confined to lateral movement by two slots in the plate (6.2) and can be tightened by two bolts extending through the slots from the sliding plate above, just at the point where the mating gear (6.4) and the focus ring gear band (6.9) are in good contact. A T-channel mounting could also be used instead of slots to adjust the motor/gear position. The focus ring gear band (6.9) in this example is attached to a steel band (6.8) for easy attachment to the focus ring.

The sensitivity in this embodiment as in previous examples is largely determined by the ratio of the focus ring diameter to the diameter of the drive gear. In this case, the ratio is over 8 to 1. The highest sensitivity works out to be about 0.015 degree per step.

FIG. 7. Commercial motor-driven, linear rail adapted to execute focus ring rotation

This figure provides a block diagram showing how a commercial motor driven linear rail can be adapted to execute Method 1 by positioning the camera/lens in such a way that an extension of the lead screw, through a pulley-gear is able to rotate the focus ring. In this figure, the commercial rail system is shown as a side view and is confined by a base and two end plates (7.1, 7.4). The rail and moving platform (7.13) normally used to move mounted objects horizontally can be either ignored or removed as they are not used in this adaptation. Normally, the lead screw (7.3) does not extend beyond the end plate (7.4), but by using a longer lead screw, it can be modified such that the lead screw does extend out beyond the frame end. A small diameter pulley gear (7.5) can be attached directly to the lead screw end as shown. This drive gear (7.5) interfaces with a pulley gear band (7.8) which in turn interfaces to a gear band (7.10) that is attached to the focus ring (7.9). Though not shown here, a freewheeling pulley gear can also be added to the end plate (7.4) in such a way as to provide a tensioning mechanism to the pulley gear band (7.8). As shown, the camera (7.12) and lens (7.11) are mounted on a quick release plate (7.7). The plate is held by the clamp (7.6) which is attached directly to the end plate (7.4). The camera and lens can be easily moved to position the focus ring gear band (7.10) directly above the drive gear (7.5) below. Note that the pitch of the lead screw has no impact on the sensitivity as it is merely an extension of the motor drive axle in this use.

As in the other pulley gear embodiments already described, the sensitivity realized with this geometry is about 0.02 degrees per micro-step.

FIG. 8. Z Channel mounted lead-screw method

The sensitivity in terms of angular control of the focus ring can be enhanced from the preceding embodiments involving direct coupling of a motor axle-gear to the focus ring gear band, to instead use an indirect geometry in which the screw moves a platform in such a way as to interface to the focus ring via a rigid tab, as already utilized in the manual method displayed in FIG. 3. Unlike the previous use of a commercial rail system described in FIG. 7, the lead screw pitch and the distance between the focus ring and the end of the extension tab being moved directly determine the sensitivity obtained.

An automated version of the manual method is to replace the micrometer screw with a motor driven lead screw arrangement as shown in this figure, involving a Z-channel platform as the base, composed of a bottom surface (8.4) and a top surface (8.7). Though not shown here, the platform is attached to a tripod below by means of a quick-release clamp. The cameral/lens is attached to a quick release plate (8.7) held on the platform by the clamp (8.11) and is free to move forward and backward for alignment.

The Nema 17, 1A stepper-motor is secured to the lower base (8.2) by mechanical locking and glue between the upper platform (8.7) and the lower platform (8.4). The motor turns a 1 mm pitch lead screw (8.5). A moving nut on the screw is attached to a rectangular plate (8.6) such that the plate rests on the base surface (8.4) and thereby cannot turn, but instead causes the plate assembly to move horizontally as the screw rotates. A bar magnet (8.8) interfaces with a rigid arm/roller bearing (8.9) attached to the focus ring (8.14) by means of a clamp (8.13).

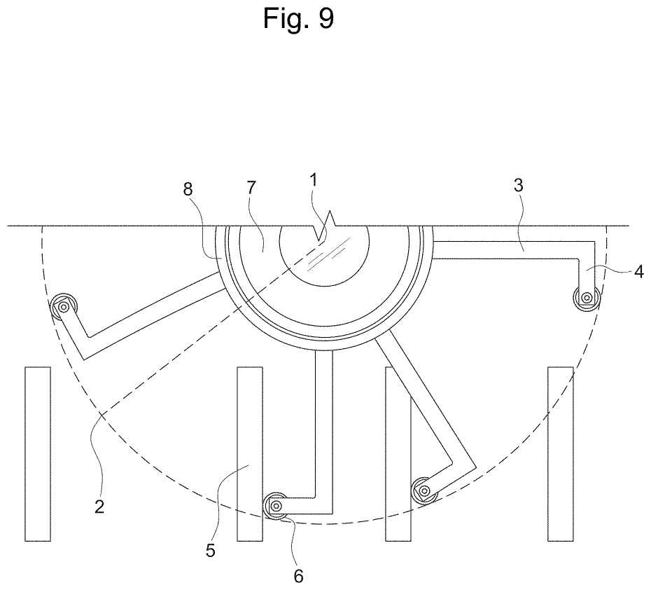

The sensitivity in this embodiment can be understood as follows—the geometry provides a ×3 mechanical advantage as suggested by FIG. 9. In this FIG. 8), the rotation circle has a circumference of pi×D or about 24 cm. Thus, at the tip of the roller bearing 1 cm movement will produce 360/24=15 degrees rotation/cm which of course will also be the angular change for the focus ring. In its normal use, the motor rotates in 200 steps to reach 360 degrees, or 1.8 degrees per step which will move the magnet 0.1 cm/200=0.005 cm per step. This means the focus ring will move 0.005 ×15=0.075 degrees per step. In micro-step mode, ( 1/16) this becomes 0.075/16=0.004 degrees rotation. This is about five times more sensitive than the pulley-gear or solid gear methods can produce and is more sensitive than needed for most uses. In fact, in our experience, a lead screw having better defined threads and a 2 mm pitch offers some advantages, still providing small angular changes <0.01 degrees, if needed.

FIG. 9. Magnetic coupling between moving plate and focus ring

An important element of this invention is the use of a rigid extension arm to couple the focus ring rotation to the linear movement of a plate/bar magnet below the lens barrel. In this figure, a front view includes the camera lens (9.7), an attached L-shaped arm (9.3, 9.4) in four different angular positions and a moving plate/bar magnet (10.5) shown in four different lateral positions.

The arm has a long leg (9.3) and a short leg (9.4). A roller bearing (9.6) is attached to the end of the short leg (9.4).

The focus ring (9.8) rotates in unison with the attached arm as the tip of the arm (at the roller bearing edge) follows an arc described by the dashed circle. Note that the magnetic bar (9.5) at the position labeled 9.5 causes the arm to be at the bottom of the circle and as the bar magnet moves to the right (driven by the motor/lead screw), the focus ring moves counterclockwise. As the plate moves to the left, the ring rotates clockwise. In this example, note that the rigid arm is positioned to be in front of the moving bar, or it would contact the long leg of the arm (9.3) at some lateral position, which would change the point of rotation control (hence step size) quite significantly in the middle of a shooting session. Since we prefer the arm positioned at the same position as the magnet, we adjust the short leg (9.4) to be long enough (longer than depicted here) that the roller bearing is always in contact with the magnet, no matter its position.

Notice the bar magnet can only be so long as to not reach the lens barrel above nor the base below. As the magnet moves, the roller bearing moves up and down the magnet, reaching the top of the magnet at lateral positions on either side of the lens. As suggested in this illustration, the arm loses contact with the magnet at some position, and the maximum rotation angle of 180 degrees cannot be achieved without some other mechanical mechanisms, not important here. In our preferred size and geometry we have control over about a 120-degree angular range such that the rigid arm moves from about the 8:00 position to 4:00 position in going from left to right.

Note that the radius of the focus ring is about ⅓ the diameter of circle followed by the roller as measured along the dashed line from point 10.1 to 10.2 in this configuration. This gives a mechanical advantage of 3. It is entirely possible, but inconvenient to greatly increase the length of the rigid arm (9.3) such that the radius of the focus ring (4 cm) might be only 1/9 the radius of the circle followed by the roller (36 cm), and the angular rotation possible will be much larger than 120 degrees. Such an arrangement is not preferred, because the lead screw provides superior mechanical advantages by itself and 120-degree movement is more than enough for most photographic subjects.

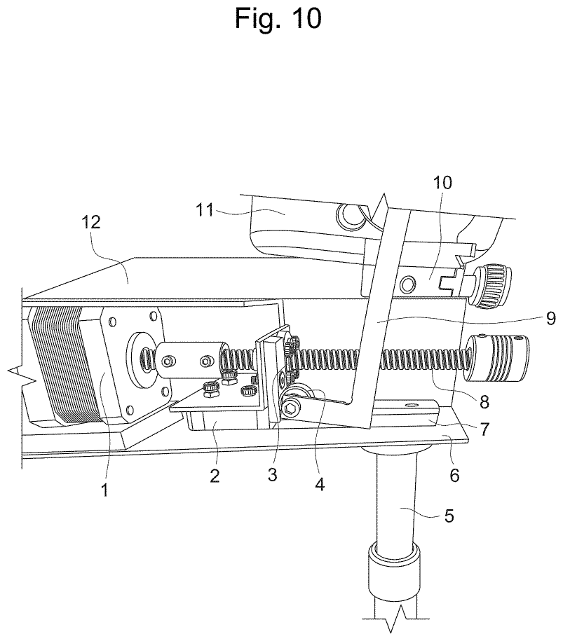

FIG. 10. Z Channel mounted Lead screw/rail method

In this figure we show a somewhat different mechanical arrangement for utilizing the stepper motor/lead screw mechanism first described in FIG. 8, where the rectangular, moving plate (magnet) is constrained from rotation by conformance to the base. In the method shown here, a linear rail provides the means to guide the magnet laterally to execute Method 1, the subject of this invention, but also provides a means to also execute Method 2 and Method 3. How that is accomplished is the subject of a second patent filing entitled “Automated apparatus to obtain images in incremental focal-distance steps using either focus ring rotation or linear translation methods”. (Turcotte)

Regarding FIG. 10, it shows camera body (10.11) mounted on the top surface (10.12) of a Z-channel platform via a quick-release clamp (10.10). A rigid L-shaped arm (10.9) extends down from the focus ring as in FIGS. 8 and 9. A roller bearing (10.4) is attached to the lower leg of the arm in such a way as to contact a vertical bar magnet (10.3). In this case, the bar magnet is attached to a moving base (10.2) which in turn is constrained to a linear rail (10.7). The rail and Nema 17 1A stepper motor (10.1) are both mounted on the bottom platform (10.6) of the Z-channel. The Z-channel base (10.6) is attached to a tripod below. The stepper motor turns a 1 mm pitch lead screw (10.8). A nut is threaded onto the screw but is attached to the plate mounted on top of the moving platform (10.2) and which also supports the vertical bar magnet (10.3). In this manner, the nut cannot rotate but causes the platform to move laterally when the motor/lead screw turns. This method provides focus ring rotation of as little as 0.004 degrees per micro-step.

FIG. 11. Electronic Controller

A relatively simple controller using inexpensive commercial hardware and electronics has been developed to manage any of the various embodiments shown earlier, in their practical execution. This requires that the controller provide means to define the image taking process in terms of speed, number and size of steps, and delay time between steps. As shown in the figure, the controller is fabricated as an aluminum box of approximate dimensions 10 cm×8 cm×4 cm.

Regarding controller functions, keypad buttons (Up, Down, Left, Right, Enter and Reset) on the top and the input/output connectors on the side of the box are all labeled. The keypad buttons on top allow the user to navigate through a list of provided configuration screens and modify settings, as described below. The Reset button resets the microcontroller (stopping any active motor motion). The Up and Down buttons are used to display the next or previous configuration screen in the list. Pressing the Right button invokes Data Entry mode allowing the value of the configuration parameter associated with the displayed screen to be modified. When in data entry mode, the Up and Down buttons increment/decrement the associated parameter by 1 and the Left and Right buttons increment/decrement the parameter value by 10. Pressing the Enter button saves the modified parameter value and exits Data Entry mode. Parameter values are stored in the microcontroller's EEPROM (non-volatile memory) so that the next use of the controller can begin with the previously used configuration.

The connectors on the side are for cables to input 12V DC power, send power to the stepper motor and activate the camera's electronic shutter.

FIG. 12. Block Diagram for electronic system

As shown in the labeled block diagram, the controller includes an embedded microcontroller board which is connected to a stepper motor control integrated circuit (IC), a liquid crystal display (LCD) board with keypad switches, and relays for camera shutter activation. One of many possible microcontrollers that could be used is the Microchip Atmega328P with integrated RAM, Flash and non-volatile memories.

The motor control IC (Allegro A4988) accepts digital input signals (digital outputs from the microcontroller) for:

| | |
|---|---|
| Enable | (supply power to stepper motor coils) |
| Step | (move motor one increment) |
| Motor Direction | (forward or reverse) |
| Step Resolution | (amount of each motor movement increment, set using |
| | MS1, MS2, MS3 ([Micro Step] digital inputs) |

The A4988 IC is designed to operate standard bipolar stepper motors in full, half, quarter, eighth, and sixteenth-step modes.

Two camera control relays connect two contacts to a common third contact to command a connected digital camera to take a photograph. The microcontroller activates each relay using digital output pins connected to the relay coils. Optocoupler IC's could also be used instead of relays.

The display/keypad board is connected to one of the microcontroller's serial communication peripherals (inter-integrated circuit port). The microcontroller sends commands for display of characters on the LCD and to read the state of the keypad switches. The LCD provides two rows of 16 characters for displaying/modifying system settings, activating motor movements and camera control sequences, and displaying the progress of an active shooting sequence.

FIG. 13. Flowchart showing shooting sequence

This figure shows the logic flow diagram utilized by the controller from the start to the end of any single shooting sequence. It is self-explanatory.

We claim the following regarding the subject invention:

1. A method and hardware/firmware to automatically generate any number of images using a digital camera to take pictures in sequential, user defined steps regarding focal depth into the subject by means of controlled, external rotation of the camera lens focus ring using a stepper motor, gear interfacing and electronic controls.

2. The method of claim 1 wherein the controller provides means to energize the stepper motor manually or is able to program the motor functions and trigger the camera sequentially, and allows setting all of the following parameters: number of shots, steps per shot, step resolution (size), delay time between steps (shots), and motor speed, by means which thereby allows taking a large number of still photographs, or videos while changing the focus distance.

3. The method of claim 2 wherein the controller is programed to have a continuously changing step size determined by the depth of field at each distance in the shooting sequence to maintain a step size equal to ½ the DOF at that point, thereby having longer step sizes as the distance increases and thereby optimizing the number of shots required.

4. The method of claim 1 whereby the hardware is attached directly to the lens barrel

5. The method of claim 4 wherein the driving force is applied manually to achieve the focus ring rotation by coupling an adjustment screw (tip) to a tab extending from the focus ring via a bar magnet attached to the tab and thereby magnetically coupled to the screw tip in either rotation direction.

6. The method of claim 4 wherein a stepper motor is coupled to the focus ring using a solid gear(s) matched to a gear-band affixed to the focus ring.

7. The method of claim 4 wherein the stepper motor is coupled to the focus ring using a pulley-gear band matched to a gear-band affixed to the focus ring.

8. The method of claim 1 whereby the hardware and camera/lens are attached to a solid plate which is attached to a tripod.

9. The method of claim 8 whereby the stepped images of different focal length are obtained manually by rotation of a fine adjustment screw contacting a rigid arm projecting from the focus ring, thereby incrementally rotating it and changing the focal distance.

10. The method of claim 8 whereby the image collection process is fully automated, powered by a battery powered stepper motor and motor controller.

11. The method of claim 10 whereby the interface between the stepper motor and the lens focus ring is accomplished using solid gear(s) on the motor axis, mating with a gear band affixed to the focus ring, thereby rotating it and changing the focal distance.

12. The method of claim 10 whereby the interface between the stepper motor and the lens focus ring is accomplished using a pulley-gear belt connecting the motor axis with a gear band affixed to the focus ring, thereby rotating it and changing the focal distance.

13. The method of claim 1 whereby the hardware and camera/lens are attached to Z-shaped structure and which is attached to a tripod.

14. The method of claim 13 whereby the stepper motor is attached to a lead screw by which means a nut/plate is moved horizontally by action of the stepper motor and for which the camera/lens is mounted centrally on top of the Z-channel and the motor/lead screw is attached to the lower horizontal surface of the channel such that the long axes of the camera lens and leadscrew are at 90 degrees from each other.

15. The method of claim 14 wherein the moving nut/plate is restricted from rotation by having the rectangular plate in close contact to the mounting plate, or is “pinned” by having a tab attached to the moving plate slide along a slot cut into the mounting plate, or is pinned using a T-channel mounted to the plate, or by attaching the plate to a platform confined to the base plate on a linear rail—all means by which the plate cannot rotate but only move horizontally in response to the motor/lead screw rotation, and thereby causes rotation of the focus ring, by interfacing to the ring using a rigid arm extending from the ring down to the moving plate/magnet.

16. The method of claim 15 wherein the hypotenuse of the L shaped tab (including the extension caused by the roller bearing) as well as the moving plate/bar magnet are slightly less in height than the distance between the focus ring (above) and the platform below, on which the motor/lead screw rail or other pinning mechanism are attached, and are about ⅓ as long as the lead screw, thereby causing the angular range of focus ring rotation to be about 120 degrees.

17. The method of claim 1 by which the images are obtained in the form of a video during which filming the focal distance is continuously changed and the video then computer processed to extract individual frames and which then can be processed as a stack to obtain the high resolution, in-depth final image.

18. The method of claim 17 whereby a focus-follow motor and hardware are controlled for this purpose of capturing still frames as a function of distance, not for the purpose of capturing motion as currently employed.

19. The method of claim 1 in which a commercial motor/lead screw/linear rail system is adapted by extending the lead screw out from the system end plate, adding a drive gear to the end of the screw and also mounting the camera/lens on top of the end plate in such a way that a gear band on the focus ring aligns with the drive gear below and thereby, through use of a pulley gear band allows motor axle rotation to rotate the focus ring.

20. The method of claim 1 in which a commercial motor/lead screw/linear rail system is mounted on a tripod (a) at a 90 degree angle and below the camera/lens mounted on a second tripod (b), or with the right structural frame everything can be mounted on one tripod—in such a way that the moving carriage on the linear rail is able to magnetically couple to a rigid tab extending down from the focus ring, thereby controlling it's rotation.
